(19) United States
(12) Patent Application Publication
(10) Pub. No.: US 2013/0236712 A1
(43) Pub. Date: Sep. 12, 2013

(54) METAL LAMINATES AND METHODS THEREOF

(71) Applicants: Daniel Serafin, Baden, PA (US); Janell Abbott, New Stanton, PA (US); Robert Bombalski, Pittsburgh, PA (US); Al Askin, Lower Burrell, PA (US); Edmund W. Chu, Export, PA (US)

(72) Inventors: Daniel Serafin, Baden, PA (US); Janell Abbott, New Stanton, PA (US); Robert Bombalski, Pittsburgh, PA (US); Al Askin, Lower Burrell, PA (US); Edmund W. Chu, Export, PA (US)

(73) Assignee: Alcoa Inc.

(21) Appl. No.: 13/412,873

(22) Filed: Mar. 6, 2012

(51) Int. Cl. B32B 7/02; B32B 37/12; B32B 27/38; B32B 37/10; B32B 15/08; B32B 37/02; B32B 38/16

(52) U.S. Cl. 428/215; 156/278; 156/150; 428/461; 428/413

(57) ABSTRACT

Disclosed herein are metal laminates, and methods related thereto. The metal laminates have a cold rolled steel substrate having at least a first side and a second side; a backer coating disposed upon at least a portion of the first side of the cold rolled steel substrate; an adhesive disposed upon at least a portion of the second side of the cold rolled steel substrate; and an aluminum metal layer having at least a first side and a second side, at least a portion of the first side of the aluminum metal layer contacts at least a portion of the adhesive.

### CROSS-REFERENCE TO RELATED APPLICATION

This patent applications claims the benefit of and priority to prior U.S. Provisional Patent Application Ser. No. 61/454,410, filed on Mar. 18, 2011, the entire contents of which is hereby incorporated by reference in full.

### FIELD OF THE DISCLOSURE

The present disclosure relates generally to a first metal laminated to a second metal. In particular, the present disclose relates to an aluminum layer laminated to a cold rolled steel substrate, and methods thereof.

### BACKGROUND

In a prior embodiment, non-corrosive metal layers (such as stainless steel sheets) have been laminated to aluminum substrates. Such embodiments are disclosed, without limitation, in U.S. Pat. No. 6,051,327.

In a further prior embodiment, aluminum layers (such as bright finish aluminum top sheets) have been laminated to aluminum substrates. Such embodiments are disclosed, without limitation, in U.S. Pat. No. 6,235,409.

### SUMMARY OF THE DISCLOSURE

In accordance with an illustrative embodiment of the present disclosure, illustrated herein is a metal laminate. The metal laminate may include a cold rolled steel substrate having a first side and a second side. The metal laminate may further include a backer coating disposed upon at least a portion of the first side of the cold rolled steel substrate and an adhesive disposed upon at least a portion of the second side of the cold rolled steel substrate. Further, the metal laminate may include an aluminum metal layer having at least a first side and a second side, wherein at least a portion of the first side of the aluminum metal layer contacts at least a portion of the adhesive.

In accordance with a further illustrative embodiment of the present disclosure, illustrated herein is a process for forming a metal laminate. The process may include depositing a backer coating on at least a portion of a first side of a cold rolled steel and depositing an adhesive on at least a portion of a second side of a cold rolled steel to form a prepared cold rolled steel substrate. The process may continue to contact at least a portion of a first side of an aluminum metal layer having a first and second side with at least a portion of the adhesive deposited to at least a portion of the second side of the cold rolled steel. Finally, the prepared cold rolled steel substrate and aluminum metal layer may be pressed through a laminating nip to form the metal laminate.

While metal laminates and methods thereof will be described in connection with various preferred illustrative embodiments, it will be understood that it is not intended to limit the metal laminates and methods thereof to those embodiments. On the contrary, it is intended to cover all alternatives, modifications, and equivalents as may be included within the spirit and scope of the invention as defined by the claims.

### BRIEF DESCRIPTION OF THE DRAWING FIGURES

The drawing figures are not necessarily to scale and certain features may be shown exaggerated in scale or in somewhat schematic form in the interest of clarity and conciseness, wherein:

FIG. 1 is a perspective, cut-away view of one embodiment of a metal laminate of the present disclosure; and

FIG. 2 is a flowchart illustrating an embodiment of a process for forming a metal laminate of the present disclosure.

### DETAILED DESCRIPTION OF THE EMBODIMENT

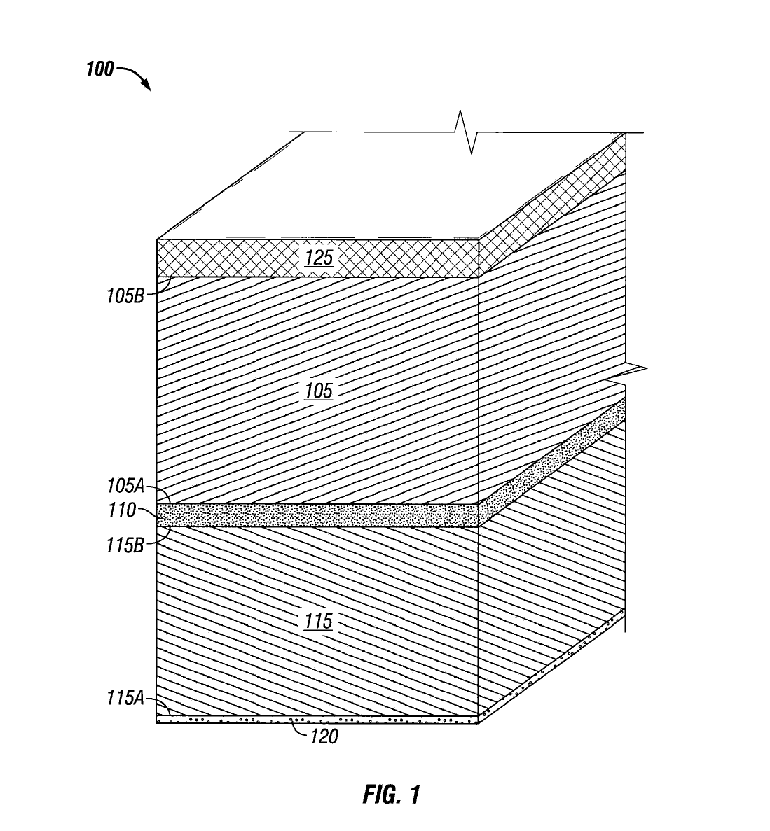

With reference to FIG. 1, a metal laminate 100 is provided. In an embodiment, the metal laminate 100 may include an aluminum metal layer 105; an adhesive 110; a cold rolled steel substrate 115; a backer, or backer coating, 120; and an optional top coat 125. The cold rolled steel substrate 115 may be formed into any shape including a sheet, foil, plate, strip, or bar, having a first side 115A and a second side 115B. The backer 120 may be disposed on (or otherwise introduced to) at least a portion of the first side 115A of the cold rolled steel substrate 115. The adhesive 110 may be disposed on (or otherwise introduced to) at least a portion of the second side 115B of the cold rolled steel substrate 115. The aluminum metal layer 105 may be formed into any shape including a sheet, foil, plate, strip, or bar having a first aluminum side 105A and a second aluminum side 105B. At least a portion of the first aluminum side 105 A of the aluminum metal layer 105 may be contacted with (or otherwise introduced with) at least a portion of the adhesive 110. In this manner, the adhesive 110 may join, bond, affix, glue, or otherwise connect the aluminum metal layer 105 and the cold rolled steel substrate 115. In a further embodiment, a top coat may 125 be disposed on (or otherwise introduced to) at least a portion of the second aluminum side 105B of the aluminum metal layer 105.

The backer 120 may be formed of any material and of a thickness suitable to protect the cold rolled steel substrate 115 and/or metal laminate 100 from corrosion, wear, and degradation when exposed to a bright dip and anodizing process (explained in further detail below). Non-limiting examples of suitable materials include epoxies, acrylics, acrylic urethanes, fluoropolymers, melamines, styrene-butadiene, polyesters, and the like. In an embodiment, the backer 120 may have an average thickness ranging from between about 0.1 mils and about 1 mil. In an embodiment, the backer 120 may be applied to the first side 115A of the cold rolled steel substrate 115 as a substantially even coating by any suitable method including spraying, brushing, roll coating, and the like. Some irregularities in the thickness of the backer 120 may be expected in various embodiments depending on the application method.

In an embodiment, the cold rolled steel substrate 115 may be any steel rolled below its recrystallization temperature. Non-limiting examples of suitable cold rolled steel substrates 115 include soft or half hard temper 1010 obtained from TW Metals, Inc. In an embodiment, the cold rolled steel substrate 115 may be formed into any suitable flat shape including without limitation a sheet, foil, plate, strip, or bar having an average thickness ranging from between about 0.003 inches and about 0.050 inches, and alternatively between about 0.003 inches and about 0.025 inches.

The adhesive 110 may be formed of any material and of a thickness suitable to join, bond, affix, glue, or otherwise connect the aluminum metal layer 105 and the cold rolled steel substrate 115. Non-limiting examples of suitable adhesive materials include thermoplastic films such as polypropylene thermoplastic and epoxy resins such as two-party epoxies. Further non-limiting examples of suitable adhesive materials may include polyurethane resins (such as Robond™ L-2150, available from The Dow Chemical Company); formulated polypropylene dispersions (such as MOR-AD™ M-805, available from The Dow Chemical Company); epoxy coatings (such as MOR-AD™ M-801, available from The Dow Chemical Company); and polyolefins and polyesters available from Bemis Associates Inc., located in Shirley, Mass. In an embodiment, the adhesive 110 may have an average thickness ranging from between about 0.3 mils and about 3 mils. In an embodiment, the adhesive 110 may be applied to the second side 115B of the cold rolled steel substrate 115 as a substantially even coating by any suitable method including spraying, brushing, roll coating, and the like. Some irregularities in the thickness of the adhesive 110 may be expected in various embodiments depending on the application method.

In an embodiment, the aluminum metal layer 105 may be formed of any aluminum alloy, including without limitation those selected from the group consisting of a 1xxx series, 2xxx series, 3xxx series, 4xxx series, 5xxx series, 6xxx series, 7xxx series, and 8xxx series aluminum alloys. In particular embodiments, aluminum metal layer 105 may be a 1xxx series or a 5xxx series aluminum alloy. Optionally, the aluminum metal layer 105 may be 5657, 1085, or 3003. In an embodiment, the aluminum metal layer 105 may be formed into any suitable flat shape including without limitation a sheet, foil, plate, strip, or bar having an average thickness ranging from between from about 0.0005 inches and about 0.030 inches; alternatively between about 0.001 inches and about 0.030 inches.

The optional top coat 125 may be formed of any material and of a thickness suitable to protect the aluminum metal layer 105. Non-limiting examples of suitable top coats include aluminum oxides and materials suitable for use also as the backer 120 including without limitation epoxies, acrylics, acrylic urethanes, fluoropolymers, melamines, styrene-butadiene, and the like . In an embodiment, the top coat 125 may have an average thickness ranging from between about 0.05 mil and about 5.0 mil, alternatively between about 0.1 mil and 1 mil, alternatively between about 0.3 mil and about 0.5 mil. In an embodiment, the top coat 125 may be applied to the second aluminum side 105B of the aluminum metal layer 105 as a substantially even coating by any suitable method including spraying, brushing, rolling, and the like. In an embodiment, the top coat 125 may be applied to the second aluminum side 105B of the aluminum metal layer 105 before the aluminum metal layer 105 is mated with the cold rolled steel substrate 115. Alternatively (as discussed further below), the top coat 125 may be applied to the second aluminum side 105B of the aluminum metal layer 105 after the metal laminate 100 is formed. Some irregularities in the thickness of the top coat 125 may be expected in various embodiments depending on the application method.

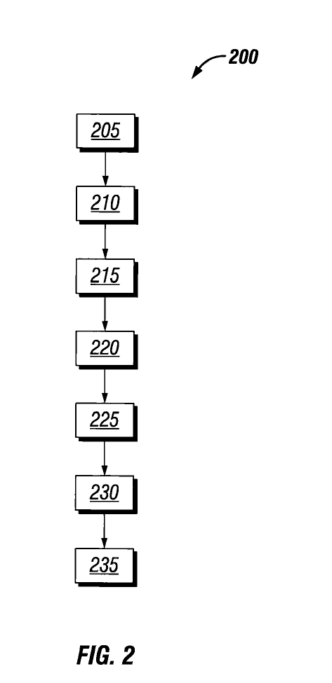

With reference to FIG. 2, a flow chart illustrating an embodiment of a process for forming a metal laminate 200 is provided. In an embodiment, the process may include a step of unwinding 205 cold rolled steel and forming it into any suitable flat shape including without limitation a sheet, foil, plate, strip, or bar having a first side and a second side. The unwound cold rolled steel may then be optionally cleaned and pretreated 210. Suitable cleaning and pretreatment methods are generally known. A backer may be applied to, or deposited on, the first side of the cold rolled steel and an adhesive may be applied to, or deposited on, the second side of the cold rolled steel in step 215. As described above, suitable methods of applied or depositing the backer and adhesive may include spraying, brushing, rolling, and the like. Following step 215, the cold rolled steel may then optionally heated in an oven in step 220, until the cold rolled steel reaches between 150° F. and 500° F., or between 150° F. and 400° F.; optionally the oven is set to between 150° F. and 650° F., or between 150° F. and 500° F., and the cold rolled steel reaches a lesser temperature than the set point of the oven. In an embodiment, the optional heating step 220 may activate, or soften, the adhesive applied in step 215. In step 225, an aluminum metal layer may be contacted with the adhesive applied in step 215 to form a preformed metal laminate. Preferably, the aluminum metal layer is sized to align with and be laid on top of the cold rolled steel substrate. In step 230, the preformed metal laminate is pressed, or rolled, through a laminating nip to form a metal laminate. The metal laminate may be optionally trimmed or otherwise processed in subsequent steps (not shown). For example, (not shown) the metal laminate 100 may be recoiled and run through a coil coating line to apply a clear, tinted, or pigmented top coat 125 via reverse roll coating, spray coating, electrocoating, or powder coating onto the aluminum metal layer 105 after step 230. Alternatively, (also not shown) the metal laminate 100 may be recoiled and cut into blanks, which may be then formed into three-dimensional parts, the aluminum metal layer 105 of which may be coated (by optionally cleaning the surface of the aluminum metal layer 105, optionally conversion coating for improved adhesion, spray/dip/powder coating) with a top coat 125 (optionally a clear, tinted, or pigmented coating system) in batches after step 230. In optional step 235, the metal laminate 100, or a portion thereof, may be subjected to a bright dip and anodizing process.

The bright dip and anodizing process of step 235, referred to by the acronym BDA, may include at least the following steps: 1. Surface cleaning, 2. Chemical brightening, 3. Anodizing, 4. optionally Dyeing, and 5. Sealing. Preparation of BDA samples as a substrate for thin film depositions may require an additional optional process step: 6. Desmut.

Without wishing to be bound by the theory, Applicant believes that surface cleaning may remove oil, dirt, and grease from the aluminum surface resulting from fabrication and/or transportation and storage. Cleaning may be accomplished by vapor degreasing or solvent wiping if the surface is heavily oiled, followed by immersing the laminate, or portion thereof, in an inhibited alkaline cleaner, rinsing in cold water, then immersing in a mild acid cleaner and rinsing finally in cold water.

Chemical brightening, also referred as “bright dip,” may be used where a bright and specular finish is required and buffing or electropolishing are not convenient or economical. Specifically, the bright dip may employ a hot solution comprising phosphoric acid and certain additives, with a dipping period of about 15 seconds to about 5 minutes. Without wishing to be bound by the theory, Applicant believes that with bright dip, very good surface leveling and brightening can be obtained on most commercial wrought alloys.

The anodizing electrolytic process may produce an oxide coating on laminate, or portion thereof, for both protective and decorative purposes. In an embodiment, the anodizing process may produce a hard, adherent, protective, and transparent coating of aluminum oxide, about 0.05 mil to about 1.5 mil thick, alternatively about 0.3 to about 0.5 mil thick, alternatively about 0.06 to about 0.08 mil thick, on the brightened aluminum surface. The protective and clear oxide coating may be produced in a solution containing between about 15 wt. % and 20 wt % sulfuric acid. The oxide coating thickness may be produced in electrochemical proportion to the electric current employed, or to the time of coating if the electric current remains constant. Without wishing to be bound by the theory, Applicant believes that the sulfuric acid electrolyte may be cooled to maintain a temperature of 68°-72° F. to maintain the hardness and transparency of the oxide coating. The oxide last produced may be between the metal and the previously produced oxide. As a result, without wishing to be bound by the theory, the outer surface of the oxide coating may be in contact with the sulfuric acid electrolyte from the start. The electrolyte may have some solvent action on the oxide coating which, in combination with the passage of electric current through the oxide, may cause formation of predictable submicroscopic pores in the oxide coating. The pores may be too small, approximately 120 Angstroms in diameter, to be seen with a light microscope. There may be as many as one trillion pores per square inch. They are large enough, however, to permit the entrance of aqueous solutions.

In an embodiment, a dye may be deposited, coated, or otherwise introduced to the anodized and unsealed metal laminate. The dye may be absorbed into, or otherwise drawn into by capillary action, the pores of the metal laminate in order to color the anodized and unsealed metal laminate. Suitable dyes may include, without limitation, liquid organic dyes having suitable sizes to fit within the pores of the anodized and unsealed metal laminate, which may be obtained from Clariant Corporation located in Charlotte, N.C.

In an embodiment, sealing may be applied to treat and make the porous oxide Coating—formed in the anodizing process—impermeable, non-adsorptive, and nonstaining. Without wishing to be bound by the theory, Applicant believes that the oxide coating, being porous, lowers the coating's resistance to corrosion and permits undesirable staining and coloring. Sealing may be accomplished in a number of ways; the selection of the method may be dependent upon the article being sealed and the service to which it will be subjected. Generally, sealing may be accomplished by treating anodized surfaces in hot water. Addition of nickel acetate to the hot water may increase the resistance to corrosion and general chemical attack of the oxide coating. Nickel acetate may allow for lowering of the sealing bath temperature and treatment time. In an embodiment, the sealing process may convert the aluminum oxide to a hydrated aluminum oxide resembling Boehmite, an aluminum oxide hydrate, (Al₂O₃13 H2O). The conversion to an aluminum oxide hydrate may be accompanied by an increase in the volume of the coating which allows for the closing of the pores in the oxide coating. Sealing in a nickel acetate solution may cause additional precipitation of colloidal nickel hydroxide within the pores of the oxide coating. Nickel acetate sealing, however, produces a loose powdery sealing smut on the surface which, if not removed, interferes with the adhesion of the thin film stack on the sealed oxide coating.

Desmut may be necessary in the preparation of the anodized and sealed substrate for the thin film to remove the visible layer of a powdery surface deposit on the oxide coating that is a result of the sealing process. The deposited smut may be composed of nickel hydroxide and aluminum oxide hydrate, (Al2O3—H2O). Removal of the smut may be accomplished by immersing the anodized and sealed surface into a 15 or 20 wt. % sulfuric acid anodizing electrolyte at 80° F. for 1-3 minutes. Immersion in the acid may be followed by a cold water rinse and physical wiping of the anodized surface with a clean soft cloth under constantly running deionized water. The desmutted surface may be finally dried by impingement with warm dry air.

The bright dip can be provided by phosphoric and nitric acids between 70-80 wt. % and 1-4 wt. %, respectively. In an embodiment, the bright dip can be provided by phosphoric and nitric acids between 70-80 wt. % and 2-4 wt. %, respectively. Copper may be added to enhance the final brightness by depositing in the valleys and enhancing dissolution of the peaks. The solution may be used at between about 180° and 240° F., alternatively between about 190° and about 200° F., with vigorous agitation. Alternatively the bright dip may be provided as by sulfuric acid between about 15 and 30 wt % and phosphoric acid between about 70 and 85 wt %. This alternative system preferably does not contain copper or nitric acid. The alternative bright dip system may be used at between about 175° and about 210° F.

In an embodiment, the metal laminate may be bright dipped using a racking system that electrically isolates the cold rolled steel substrate; or in other words, the rack may ensure that electrical contact is made to the aluminum surface only.

### EXAMPLE 1

A sample of 5657 alloy aluminum laminated to 0.008 ½ hard cold rolled steel using a solid 0.003 poly adhesive was bright dipped and anodized. The cold rolled steel side was coated with a strippable styrene-butadiene coating for protection in the chemical baths. Using a racking system, wherein electrical contact was made to the aluminum surface only, the sample was processed through a bright dip followed by anodizing for 20 min in sulfuric acid. This was followed by a 10 min seal in Nickel acetate solution at 185° F. The result was the aluminum anodized and the cold rolled steel was unaffected.

Although explanatory embodiments have been shown and described, it would be appreciated by those skilled in the art that changes, alternatives, and modifications all falling into the scope of the appended claims and their equivalents can be made in the embodiments without departing from spirit and principles of the disclosure.

1) A metal laminate comprising:
a cold rolled steel substrate having at least a first side and a second side;
a backer coating disposed upon at least a portion of the first side of the cold rolled steel substrate;
an adhesive disposed upon at least a portion of the second side of the cold rolled steel substrate; and
an aluminum metal layer having at least a first side and a second side, at least a portion of the first side of the aluminum metal layer contacting at least a portion of the adhesive.

2) The metal laminate of claim 1, further comprising a top coat disposed upon at least a portion of the second side of the aluminum metal layer.

3) The metal laminate of claim 1, wherein the backer coating is selected from the group consisting of epoxies, acrylics, acrylic urethanes, fluoropolymers, melamines, styrene-butadiene, and polyesters.

4) The metal laminate of claim 1, wherein the adhesive is selected from the group consisting of a thermoplastic film, an epoxy resin, a polyurethane resin, a formulated polypropylene dispersion, an epoxy coating, a polyolefin, and a polyester.

5) The metal laminate of claim 4, wherein the adhesive is a polypropylene thermoplastic or a two-part epoxy.

6) The metal laminate of claim 1, wherein the aluminum metal layer is an aluminum alloy selected from the group consisting of a 1xxx series, 2xxx series, 3xxx series, 4xxx series, 5xxx series, 6xxx series, 7xxx series, and 8xxx series aluminum alloy.

7) The metal laminate of claim 1, wherein the aluminum metal layer is an aluminum alloy selected from the group consisting of a 1xxx series and a 5xxx series aluminum alloy.

8) The metal laminate of claim 2, wherein the top coat is an aluminum oxide.

9) The metal laminate of claim 1, wherein the average thickness of the cold rolled steel substrate ranges from about 0.003 inches to about 0.05 inches; the average thickness of the backer ranges from about 0.1 mils to about 3 mils, alternatively from about 0.1 mils to about 1 mil; the average thickness of the aluminum metal layer ranges between about 0.001 inches to about 0.030 inches; and the average thickness of the adhesive ranges from about 0.0005 inches to about 0.030 inches.

10) A process for forming a metal laminate comprising:
depositing a backer coating on at least a portion of a first side of a cold rolled steel substrate and depositing an adhesive on at least a portion of a second side of a cold rolled steel substrate to form a prepared cold rolled steel substrate;
contacting at least a portion of a first side of an aluminum metal layer having a first and second side with at least a portion of the adhesive deposited to at least a portion of the second side of the cold rolled steel substrate; and
pressing the prepared cold rolled steel substrate and aluminum metal layer though a laminating nip to form the metal laminate.

11) The process of claim 10, further comprising cleaning and pre-treating the cold rolled steel substrate before the step of depositing a backer on at least a portion of a first side of a cold rolled steel substrate and depositing an adhesive on at least a portion of a second side of a cold rolled steel substrate to form a prepared cold rolled steel substrate.

12) The process of claim 10, wherein the prepared cold rolled steel substrate is heated within an oven between 150° F. and 650° F. before the step of contacting at least a portion of a first side of an aluminum metal layer having a first and second side with at least a portion of the adhesive deposited to at least a portion of the second side of the cold rolled steel substrate.

13) The process of claim 10, wherein a top coat is deposited on at least a portion of the second side of the aluminum metal layer before the step of contacting at least a portion of a first side of an aluminum metal layer having a first and second side with at least a portion of the adhesive deposited to at least a portion of the second side of the cold rolled steel substrate.

14) The process of claim 10, further comprising the step subjecting at least a portion of backer of the metal laminate to a bright dipping and anodizing process.

15) The process of claim 14, wherein the bright dipping and anodizing process further includes the steps of surface cleaning; chemical brightening; anodizing; dyeing; sealing; and optionally desmut.

16) The process of claim 10, wherein the backer coating is selected from the group consisting of epoxies, acrylics, acrylic urethanes, fluoropolymers, melamines, styrene-butadiene, and polyesters; the adhesive is selected from the group consisting of a thermoplastic film, an epoxy resin, a polyurethane resin, a formulated polypropylene dispersion, an epoxy coating, a polyolefin, and a polyester; and the aluminum metal layer is an aluminum alloy selected from the group consisting of a 1xxx series, 2xxx series, 3xxx series, 4xxx series, 5xxx series, 6xxx series, 7xxx series, and 8xxx series aluminum alloy.

17) The process of claim 16, wherein the adhesive is a polypropylene thermoplastic or a two-part epoxy; the aluminum metal layer is an aluminum alloy selected from the group consisting of a 1xxx series and a 5xxx series aluminum alloy.

18) The process of claim 13, wherein the top coat is an aluminum oxide.

19) The process of claim 10, wherein the average thickness of the cold rolled steel substrate ranges from about 0.003 inches to about 0.05 inches; the average thickness of the backer ranges from about 0.1 mils to about 1 mil; the average thickness of the aluminum metal layer ranges between about 0.001 inches to about 0.030 inches; and the average thickness of the adhesive ranges from about 0.0005 inches to about 0.030 inches.
